(19) United States
(12) Patent Application Publication
(10) Pub. No.: US 2012/0075555 A1
(43) Pub. Date: Mar. 29, 2012

(54) LIQUID CRYSTAL DISPLAY APPARATUS AND LIGHT EMITTING ASSEMBLY WITH LIGHT TRANSMISSION CONTROL ELEMENTS FOR ILLUMINATING SAME

(76) Inventors: Jeffery R. Parker, Richfield, OH (US); Kurt R. Starkey, Strongsville, OH (US); Fumitomo Hide, San Jose, CA (US)

(21) Appl. No.: 13/321,447

(22) PCT Filed: Jun. 3, 2010
(86) PCT No.: PCT/US10/37198

§ 371 Date: Nov. 18, 2011

Related U.S. Application Data
(60) Provisional application No. 61/183,595, filed on Jun. 3, 2009.

(51) Int. Cl. G02F 1/13357

(52) U.S. Cl. 349/62

(57) ABSTRACT

A liquid crystal display apparatus (500) including a liquid crystal display (LCD) panel (502), a light emitting assembly (501) arranged to illuminate the LCD panel, and a light conditioning element (510) between the light emitting assembly and the LCD panel. The light emitting assembly includes a planar optical conductor (158) characterized by a length and a width. The optical conductor has a light input surface (225), light transmission control elements (151) and well defined light extracting optical elements (157) configured to redirect light received at the light input surface out from the optical conductor. The light transmission control elements divide the optical conductor into independently operable light emitting regions (152). An LED light source (156) is optically coupled to each of the light emitting regions adjacent the light input surface of the optical conductor. Each LED light source is small relative to the length and width of the optical conductor.

### TECHNICAL FIELD

A liquid crystal display apparatus including a liquid crystal display panel and a light emitting assembly with light transmission control elements to provide illumination to the LCD panel.

### BACKGROUND

Most liquid crystal display (LCD) apparatuses employ a light emitting assembly to provide backlighting for an LCD panel that functions as a light valve array. In conventional LCDs, fluorescent lamps such as cold cathode fluorescent lamps (CCFLs) have been used as light sources in the light emitting assembly. The light emitting assembly is located behind the LCD panel, while the viewer is located in the front of the LCD panel. In this configuration, the light emitting assembly is also referred to as a backlight assembly. FIG. 1 is a schematic plan view showing a conventional light emitting assembly 100 including fluorescent lamps 101, 103, 105, 107, 109. The fluorescent lamps are shown extending across most of the width of the light emitting assembly and are held in place on their ends by frames 102 and 104, which also contain electrical connections for the fluorescent lamps.

A cross sectional schematic view showing the light emitting assembly, taken along line 2-2 shown in FIG. 1, is shown in FIG. 2. FIG. 2 additionally shows the some other components of a conventional display apparatus. Fluorescent lamps 101, 103, 105, 107, 109 are mounted in a light chamber 106. The fluorescent lamps emit light in all directions in the light chamber. The interior surface of the light chamber facing the fluorescent lamps has a reflective layer, film, or coating 108 that redirects the light from the fluorescent lamps towards a diffuser plate 110. The light passes through diffuser plate 110 and a diffuser film 112. The light then passes through a prism film 114, which collimates the light in a preferred direction, e.g., a direction more normal to the surface of an LCD panel 111. The light is polarized by a polarizer film 113 before entering LCD panel 111 and then passes through another polarizer film 115 after leaving the LCD panel. The spacing between the array of fluorescent lamps and the diffuser plate 110 is sufficient to allow the light emitted by the lamps to spread laterally.

There has been increasing use of light emitting diodes (LEDs) as light sources in light emitting assemblies. One example of such a conventional light emitting assembly is schematically shown in the top view shown in FIG. 3. FIG. 3 shows a light chamber 120 which contains a 2-dimensional array of top-emitting LEDs 122 that, when the light emitting assembly is used to illuminate an LCD panel (not shown), emit light towards the LCD panel. This arrangement is known as a direct-lit configuration.

Another example of a light emitting assembly is shown at 130 in a cross sectional view shown in FIG. 4. This implementation is disclosed in international patent application publication no. WO 2008/133421. Light sources 144, 146 are mounted on boards 143, 145 respectively. The light sources are located at opposite ends of a light guide plate 132. Light transmission preventing grooves 134, 136 divide light guide plate 132 into blocks. Light transmission preventing grooves 134, 136 extend only part way into light guide plate 132. Light reflection grooves 133, 135 defined in light guide plate 132 reflect the light and the light is emitted through the front major surface of light guide plate 132. A reflective sheet 140 is located adjacent the rear major surface of light guide plate 132 to increase the fraction of the light emitted by LEDs 144, 145 that is emitted by light emitting assembly 130. Light guide plate 132 is made of a light transmitting plastic such as an acrylic resin. This material not only facilitates the process of forming grooves in the surface of the light guide plate but also has high light transmission. This implementation can be used to achieve an illuminated advertising function.

### BRIEF DESCRIPTION OF THE DRAWINGS

In the annexed drawings:

FIG. 1 is a schematic plan view showing a conventional light emitting assembly employing fluorescent lamps.

FIG. 2 is a schematic cross sectional view showing the light emitting assembly of FIG. 1, taken along line 2-2 thereof.

FIG. 3 is a schematic plan view showing another conventional light emitting assembly employing LED light sources.

FIG. 4 is a schematic cross-sectional view showing another conventional light emitting assembly employing LED light sources.

FIG. 5 is a schematic plan view showing an example of an optical conductor-based light emitting assembly in accordance with an embodiment of the present invention.

FIG. 6 is a schematic cross sectional view through the optical conductor shown in FIG. 5, taken along line 6-6 thereof.

FIG. 7 is a schematic cross sectional view showing part of one of the light transmission control elements of the optical conductor shown in FIGS. 5 and 6.

FIG. 8 is a schematic cross sectional view showing part of one of the light transmission control elements of another example of an optical conductor in accordance with an embodiment of the present invention.

FIG. 9 is a schematic cross sectional view showing part of one of the light transmission control elements of another example of an optical conductor in accordance with an embodiment of the present invention.

FIG. 10 is a schematic cross sectional view showing part of one of the light transmission control elements of another example of an optical conductor in accordance with an embodiment of the present invention.

FIG. 11 is a schematic cross sectional view showing part of one of the light transmission control elements of another example of an optical conductor in accordance with an embodiment of the present invention.

FIG. 12 is the schematic cross sectional view showing part of one of the light transmission control elements of another example of an optical conductor in accordance with an embodiment of the present invention.

FIG. 13 is a schematic cross sectional view showing part of one of the light transmission control elements of another example of an optical conductor in accordance with an embodiment of the present invention.

FIG. 14 is a schematic cross sectional view showing part of one of the light transmission control elements of another example of an optical conductor in accordance with an embodiment of the present invention.

FIG. 15 is a schematic cross sectional view showing part of an example of a multilayer optical conductor with a light transmission control element in accordance with an embodiment of the present invention.

FIG. 16 is a schematic cross-sectional view showing part of an example of another multilayer optical conductor with a light transmission control element in accordance with an embodiment of the present invention.

FIG. 17 is a schematic cross-sectional view showing part of the optical conductor shown in the FIG. 5, taken along line 17-17 thereof.

FIG. 18 is a schematic cross-sectional view showing part of an example of another optical conductor in accordance with an embodiment of the present invention.

FIG. 19 is a schematic cross-sectional view showing part of an example of another optical conductor in accordance with an embodiment of the present invention.

FIG. 20 is a schematic plan view showing an example of an LED light source.

FIG. 21 is a schematic cross sectional view through the LED light source shown in FIG. 20, taken along line 21-21 thereof.

FIG. 22 is a schematic plan view showing another example of a light emitting assembly in accordance with an embodiment of the present invention.

FIG. 23 is a schematic plan view showing another example of a light emitting assembly in accordance with an embodiment of the present invention.

FIG. 24 is a schematic plan view showing another example of a light emitting assembly in accordance with an embodiment of the present invention.

FIG. 25 is a schematic plan view showing another example of a light emitting assembly in accordance with an embodiment of the present invention.

FIG. 26 is a schematic plan view showing another example of a light emitting assembly in accordance with an embodiment of the present invention.

FIG. 27 is an enlarged schematic cross sectional view through the light emitting assembly shown in FIG. 26, taken along line 27-27 thereof.

FIG. 28 is a schematic cross sectional view showing an example of a light emitting assembly composed of two instances of the light emitting assembly shown in FIG. 27 arranged in tandem in accordance with an embodiment of the present invention.

FIG. 29 is a schematic cross sectional view showing an example of a light emitting assembly composed of two instances of the light emitting assembly shown in FIG. 27 arranged in tandem with the distal end of one overlapping the proximal end of the other to define a gap filled with an opaque material.

FIG. 30 is a schematic plan view showing an example of a light emitting assembly composed of a 2-dimensional, 3×3 array of optical conductors.

FIG. 31 is a schematic plan view showing an example of a light emitting assembly composed of optical conductors arrayed only in the X direction.

FIG. 32 is a schematic plan view showing an example of a light emitting assembly composed of optical constructors arrayed only in the Y direction.

FIG. 33 is a schematic plan view showing another example of a light emitting assembly composed of optical conductors arrayed only in the X direction.

FIG. 34 is a schematic plan view showing an example of a light emitting assembly composed of optical constructors arrayed only in the Y direction.

FIG. 35 is a schematic perspective view showing an example of a liquid crystal display apparatus in accordance with an embodiment of the present invention.

FIG. 36 is a block diagram showing an example of the drive circuitry for a thin film transistor array and light emitting regions of the liquid crystal display apparatus shown in FIG. 35.

FIG. 37 is a detailed block diagram showing the thin film transistor array shown in FIG. 36.

FIG. 38 is a block diagram comparing conventional backlighting to backlighting employing adaptive dimming.

FIG. 39 is a schematic timing chart showing the optical response of liquid crystal material in various rows of the LCD panel shown in FIG. 35 and the timing of the light emitting regions of the backlight assembly.

### DETAILED DESCRIPTION

Embodiments of the present invention provide a liquid crystal display apparatus including a liquid crystal display (LCD) panel, a light emitting assembly arranged to illuminate the LCD panel, and a light conditioning element between the light emitting assembly and the LCD panel. The light emitting assembly includes a planar optical conductor characterized by a length and a width. The optical conductor has a light input surface, light transmission control elements and well defined light extracting optical elements. The light transmission control elements divide the optical conductor into independently operable light emitting regions. The light extracting optical elements are on or in the optical conductor and are configured to redirect received at the light input surface out from the optical conductor. The light emitting assembly additionally has an LED light source optically coupled to each of the light emitting regions of the optical conductor and located adjacent the light input surface of the optical conductor. Each LED light source is small relative to the length and width of the optical conductor.

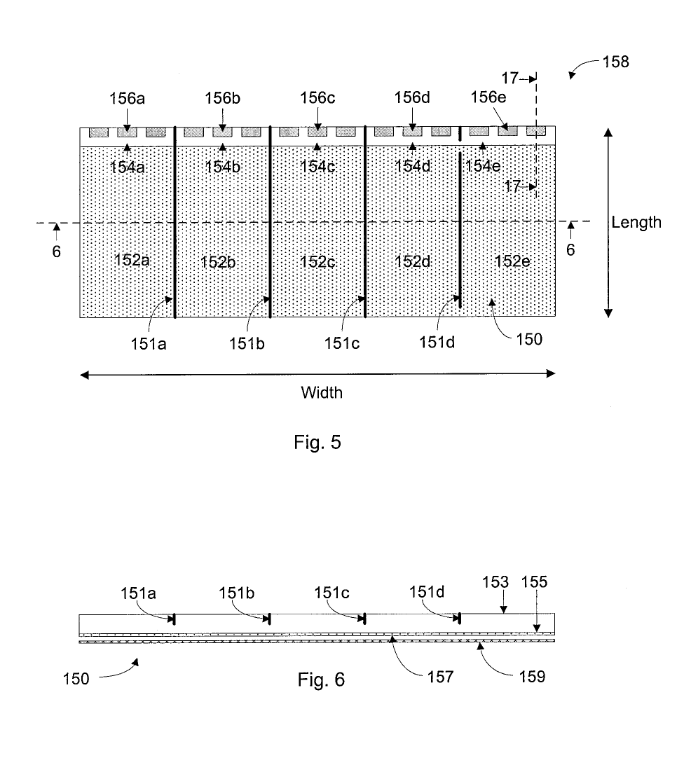

FIG. 5 is a schematic plan view showing an example of a light emitting assembly 158 in accordance with an embodiment of the invention. Light emitting assembly 158 includes a planar optical conductor 150. The optical conductor is typically made from a plastic, such as polycarbonate or poly(methylmethacrylate) (PMMA). Light transmission control elements 152a, 152b, 152c, 152d divide optical conductor 150 into light emitting regions 151a, 151b, 151c, 151d, 151e. Light transmission control elements 151a-151c are shown as extending uninterrupted along the entire length of optical conductor 150. Light transmission control element 151d is shown as extending partially along the length of the optical conductor to illustrate an alternative implementation of the light transmission elements.

Light emitting assembly 158 additionally includes LED light sources located adjacent one side of optical conductor 150 with a respective set of LED light sources 156a, 156b, 156c, 156d, 156e optically coupled to each light emitting region 152a, 152b, 152c, 152d, 152e, respectively. In the example shown in FIG. 5, each set of LED light sources is composed of three LED light sources. In an example, the LED light sources are red, green, and blue LED light sources. In another example, the LED light sources are white LED light sources. In addition, a transition region 154a, 154b, 154c, 154d, 154e is interposed between each set of LED light sources 155a-156e and respective light emitting region 151a-151e. Light from the adjacent set of LED light sources can mix and/or spread in each transition region.

Light transmission control elements 151a-151d dividing optical conductor 150 into light emitting regions 152a-152e and providing a respective set of LED light sources 156a-156e optically coupled to each of the light emitting regions makes the light emitting regions independently operable. The light emitting regions are typically operated independently by independently defining a characteristic of the light generated by the LED light sources optically coupled to each light emitting region. In an example, the effective intensity of the light generated by the LED light sources optically coupled to each light emitting region is defined by a current, a voltage, a current pulse duty cycle, a voltage pulse duty cycle, or another property of the drive applied thereto. In another example, the color of the light is independently defined for each light emitting region. This can be done, for example, by optically coupling red, green and blue LED light sources to each light emitting region and controlling the drive applied to the LED light sources of each color.

FIG. 6 is a schematic cross sectional view showing optical conductor 150, taken along line 6-6 shown in FIG. 5. The optical conductor has a front major surface 153 and a back major surface 155. Light from the LED light source (not shown) travels through the optical conductor by total internal reflection at major surfaces 153, 155.

Located on or in the back major surface 155 is a pattern of well defined light extracting optical elements 157 (not individually shown) that refract, reflect, or refract and reflect the light received from the LED light source (not shown). In the example shown, the optical elements are located on or in back major surface 155. In other examples, optical elements 157 are located on or in front major surface 153 of the optical conductor, in the interior of the optical conductor, or on or in both the front and back major surfaces of the optical conductor. The optical elements are small, and are typically very small, compared with the length and width of optical conductor 150. In an example, the optical elements have dimensions of the order of tens of micrometers, whereas optical conductor 150 has dimensions of the order of centimeters or tens of centimeters. Examples of suitable well defined optical elements are described in U.S. Pat. No. 6,752,505, assigned to the assignee of this disclosure, the disclosure of which, in the United States at least, is incorporated herein by reference.

Optical elements 157 vary in one or more of area density, number density, size, shape, height, and depth throughout optical conductor 150 in a manner that makes the light emitted from the front major surface 153 of the optical conductor within light emitting regions 152a-152e uniform in intensity within each light emitting region and between the light emitting regions. Within transitional regions 154a-154e, one or both of the area density and number density of optical elements 157 is negligible, or at least is smaller than the corresponding property of the optical elements in light emitting regions 152a-152e. In some embodiments, one or both of the area density and number density of the optical elements in transition regions 154a-154e is zero.

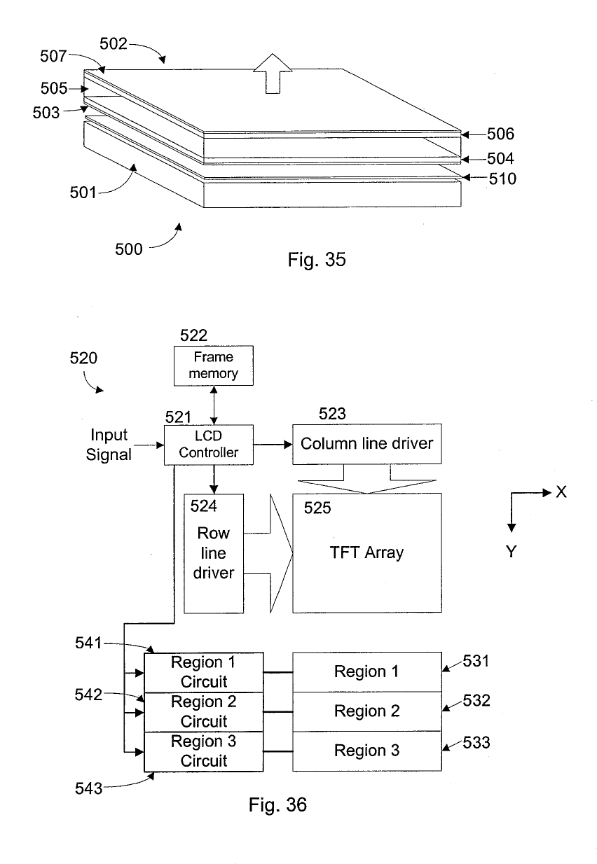

A reflective element 159 is located adjacent the major surface 155 of optical conductor 150 such that light emitted from back major surface 155 is reflected back into optical conductor 150, whence the light is emitted from front major surface 153. Reflective element 159 is typically implemented as a reflective film, sheet, or substrate. A light conditioning element (not shown) is located adjacent front major surface 153 as described in more detail below with reference to FIG. 35. Typically, the light conditioning element is composed of one or more of, or multiple ones of, a diffuser film, a diffuser plate, and a prismatic film, similar to such elements described above with reference to FIG. 2.

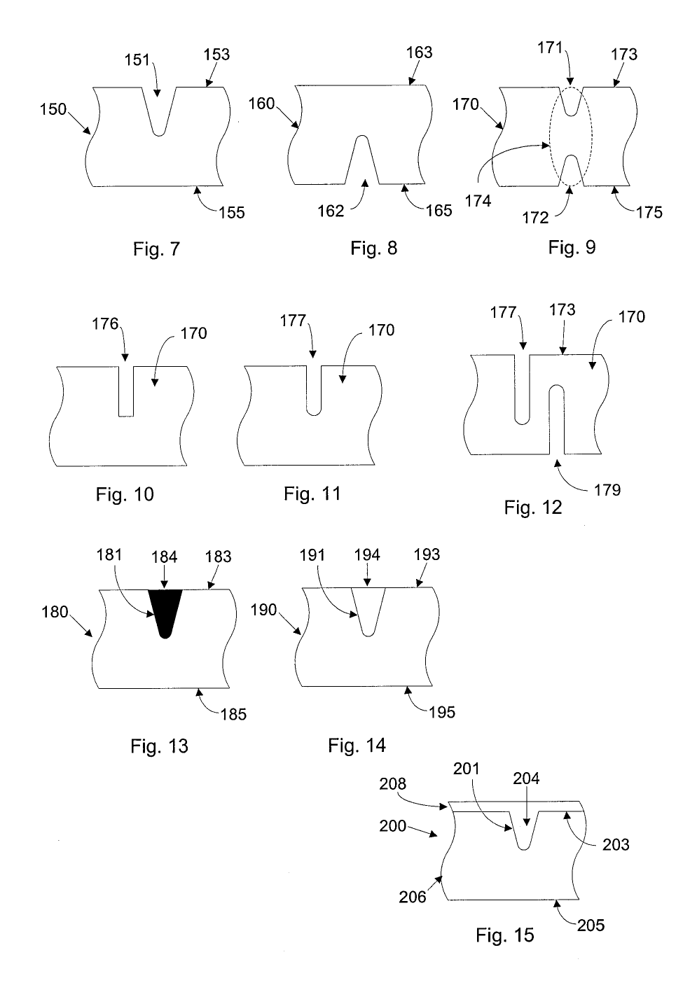

FIG. 7 is a schematic cross sectional view showing part of optical conductor 150 with an example of a light transmission control element 151 configured as a groove that extends into optical conductor 150 from the front major surface 153 thereof. The groove is sufficiently deep to control light transmission in a direction parallel to front major surface 153 but not so deep that it would make the optical conductor susceptible to breakage. Optionally, the side walls of the groove are coated with a diffusive coating, a reflective coating, or a light absorbing coating, or the groove is filled with opaque material.

FIG. 8 is a schematic cross-sectional view showing part of an example of another optical conductor 160 having a front major surface 163 and a back major surface 165. A light transmission control element 162 configured as a groove extends into optical conductor 160 from the back major surface 165 thereof.

FIG. 9 is a schematic cross-sectional view showing part of an example of another optical conductor 170 having a front major surface 173 and a back major surface 175. A light transmission control element 174 is configured as a groove 171 that extends into the optical conductor from the front major surface 173 thereof and as a groove 172 that extends into the optical conductor from the back major surface 175 thereof.

The examples of light transmission control elements shown in FIGS. 7-9 are each configured as a nominally V-shaped groove with a rounded distal end. However, the light transmission control element may be configured to have another shape, including, for example, a groove 176 having substantially straight, parallel sides with a substantially flat distal end, substantially orthogonal to the sides, as shown in FIG. 10, or a groove 177 having substantially straight, parallel sides and a rounded distal end, as shown in FIG. 11.

Also, while the light transmission control element grooves 171, 172 may extend into optical conductor 170 from both the front and back major surfaces 173, 175 of the optical conductor in substantial alignment with each other, as shown in FIG. 9, grooves 178, 179 extending into optical conductor 170 from the front and back major surfaces thereof are offset from each other, as shown in FIG. 12. Grooves 178, 179 are offset from one another in a direction parallel to front major surface 173. The offset allows the grooves to have a greater depth without an increased risk of breakage of the optical conductor.

FIG. 13 is a schematic cross-sectional view showing part of an example of another optical conductor 180 having a front major surface 183 and a back major surface 185. A light transmission control element 181 is configured as a groove that extends into optical conductor 180 from the front major surface 183 thereof. The groove is filled with light absorbing material 184. Light absorbing material 184 absorbs most of the light that reaches light transmission control element 181, and prevents such light from being re-emitted.

FIG. 14 is a schematic cross-sectional view showing part of an example of another optical conductor 190 having a front major surface 193 and a back major surface 195. A light transmission control element 191 is configured as a groove that extends into optical conductor 190 from the front major surface 193 thereof. The groove is filled with material 194 having a lower refractive index than that of the optical conductor 190. Most of the light reaching transmission control element 191 is reflected back into optical conductor 190.

FIG. 15 is a schematic cross-sectional view showing part of an example of a multilayer optical conductor 200 having a first layer 206 and a second layer 208 on the front major surface 203 of first layer 206. Second layer 208 has a lower refractive index than first layer 206. A light transmission control element 201 is configured as a groove that extends into first layer 206 from the front major surface 203 thereof. Second layer 208 is then formed or deposited on the front major surface 203 of first layer 206 such fact the lower refractive index material 204 of second layer 208 fills the groove.

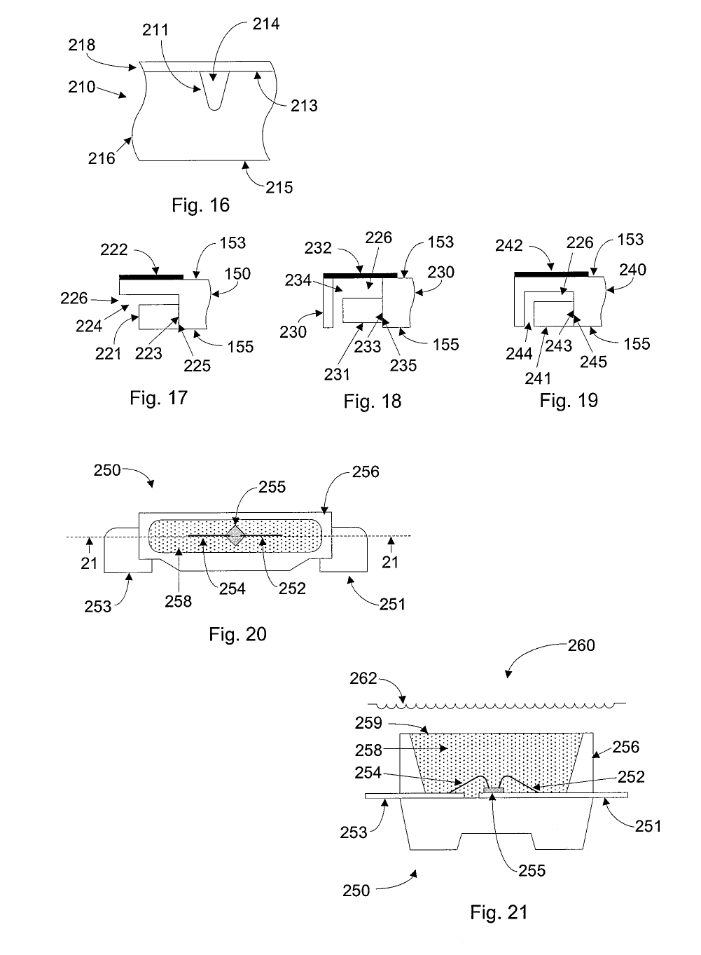

FIG. 16 is a schematic cross-sectional view showing part of an example of another multilayer optical conductor 210 having a first layer 216 and a second layer 218 on the front major surface 213 of first layer 216. A light transmission control element 211 is configured as a groove that extends into first layer 216 from the front major surface 213 thereof. Second layer 218 affixed to the front major surface 213 of first layer 216 in a manner that leaves the groove filled with air.

The mechanical strength of the optical conductor can be improved by adopting any of the configurations shown in FIGS. 13-16.

FIG. 17 is a schematic cross sectional view showing part of optical conductor 150 along line 17-17 shown in FIG. 5. A light source housing 226 is defined in optical conductor 150. In this example, the light input surface 225 of optical conductor 150 is located within light source housing 226. Mounted in light source housing 226 is an LED light source 221. LED light source 221 has a light emitting surface 223 that faces towards a light input surface 225 of optical conductor 150. In the example shown, light source housing 226 is configured as an open ended recess 224 that is open to back major surface 155 and one of the sides of the optical conductor.

LED light source 221 is electrically connected to a circuit board (not shown), which may be located on the back major surface side of optical conductor 150. Light generated by LED light source 221 enters optical conductor 150 and some of the light is refracted or reflected by the optical elements (157 in FIG. 6). An opaque layer 222 is located on or in optical conductor 150 to block stray light from the LED light source. In the example shown, opaque layer 222 is located on the front major surface 153 of optical conductor 150. In another example, opaque layer 222 is located inside light source housing 226, parallel to front major surface 153.

FIGS. 18 and 19 show alternative configurations of light source housing 226. FIG. 18 shows an optical conductor 230 having a front major surface 153 and a back major surface 155, with an opaque layer 232, and an LED light source 231 having a light output surface 233. In this example, the light input surface 235 of optical conductor 230 is located within light source housing 226. Light source housing 226 is configured as a hole 234 that extends through optical conductor 230 from the back major surface 155 to the front major surface 153 (or vice versa) thereof. LED light source 231 is located within hole 234 adjacent light input surface 235.

FIG. 19 shows an optical conductor 240 having a front major surface 153 and a back major surface 155, an opaque layer 242, a LED light source 241 having a light output surface 243. In this example, the light input surface 245 of optical conductor 240 is located within light source housing 226. Light source housing 226 is configured as a cavity 244 that extends into optical conductor 240 from the back major surface 155 thereof. LED light source 241 is located within cavity 244 adjacent light input surface 245. Alternatively, cavity 244 extends into optical conductor 240 from the front major surface 153 thereof.

The LED light sources in light emitting assemblies in accordance with embodiments of the present invention typically have a light output distribution characterized by a greater width component than height component. When the light source is mounted adjacent the optical conductor, the height component of the light output distribution is nominally orthogonal to the front major surface of the optical conductor. Moreover, such LED light sources are small compared with the width and length of the optical conductor. An example of a suitable LED light source is a side-view LED light source that has the mounting face approximately orthogonal to the direction in which the LED light source emits light.

FIG. 20 is a schematic plan view showing an example of an LED light source 250 and FIG. 21 is a schematic cross sectional view taken along line 21-21 shown in FIG. 20. First and second plate-like leads 251, 253 are positioned such that their ends face each other, and an LED chip 255 is bonded to a surface of first lead 251 near the end of the first lead adjacent second lead 253. The electrodes of the LED chip are electrically connected via wires 252, 254 to first and second leads 251, 253, respectively. In this example, the LED chip does not have a bottom electrode. First and second leads 251, 253 are fixed in position by a white resin body 256. LED chip 255 is located within the concave portion of resin body 256. The concave portion is filled with a transparent resin 258 through which light emitted by LED 255 travels before it reaches a light output surface 259. In the case of a white LED light source, transparent resin 258 includes down-conversion material, such as a phosphor, in some embodiments. LED light source 250 typically has a height less than or equal to the thickness of the portion of the optical conductor in or on which it is mounted. This allows the light emitting assembly to have a thin profile.

Additionally shown in FIG. 21 is a light input surface 260 of an optical conductor (not shown). Light input surface 260 has a microlens array 262 located adjacent the light output surface 259 of LED light source 250 when the LED light source is mounted in or on the optical conductor. The microlens array couples and distributes the light generated by the LED light source into the optical conductor. For simplicity of illustration, the microlens array has been omitted from the other Figures that show a light input surface. However, the microlens array can be used beneficially in all the embodiments shown. In other examples, the micro lens array is located on or in the light emitting surface 259 of LED light source 250.

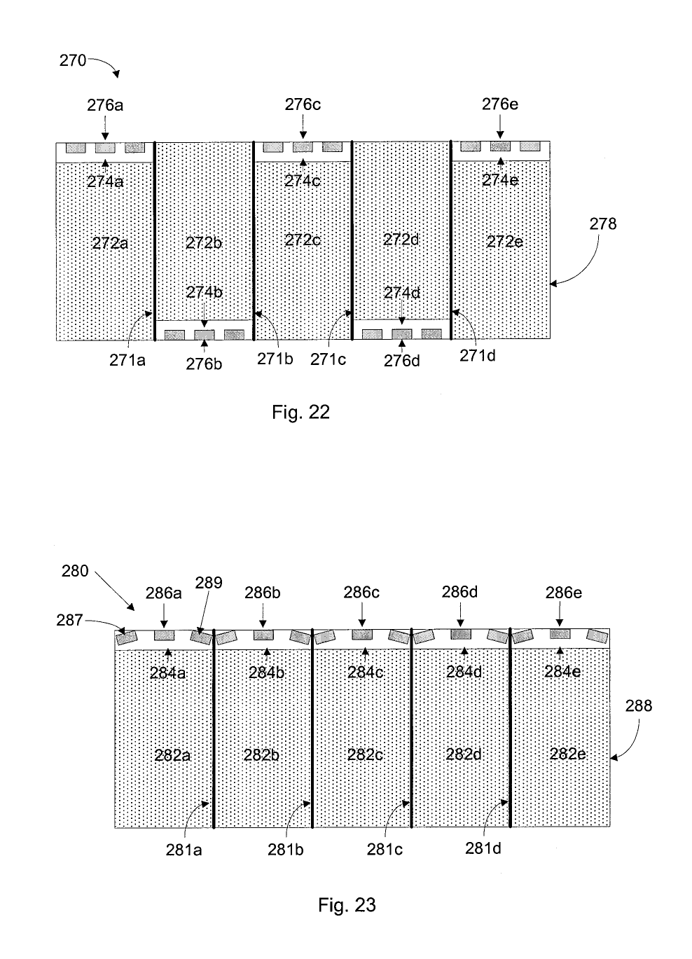

FIG. 22 is a schematic plan view showing an example of a light emitting array 270 in accordance with another embodiment of the invention. Light emitting array 270 includes a planar optical element 278. Light transmission control elements 271a, 271b, 271c, 271d divide optical conductor 278 into light emitting regions 272a, 272b, 272c, 272d, 272e. Light emitting array 270 additionally includes a respective set of LED light sources 276a, 276b, 276c, 276d, 276e located adjacent each light emitting region 276a-276e. A transition region 274a, 274b, 274c, 274d, 274e, in which light from the light sources can mix and spread, is located between each set of LED light sources 276a-276e and respective light emitting region 272a-272e. In the example shown, each set of LED light sources is composed of three LED light sources. In this embodiment, optical conductor 278 has two light input surfaces opposite one another and sets of LED light sources 276a, 276c, and 276e are located adjacent the light input surface on one side of optical conductor 278 and sets of LED light sources 276b and 276d are located adjacent the light input surface on the opposite side of optical conductor 278. This arrangement distributes thermal loading more uniformly over optical conductor 278.

FIG. 23 is a schematic plan view showing an example of a light emitting assembly 280 in accordance with another embodiment of the invention. Light emitting assembly 280 includes a planar optical conductor 288. Light transmission control elements 281a, 281b, 281c, 281d divide the optical conductor into light emitting regions 282a, 282b, 282c, 282d, 282e. Light emitting array 280 additionally includes a respective set of LED light sources 286a, 286b, 286c, 286d, 286e located adjacent each light emitting region 286a-286e. A transition region 284a, 284b, 284c, 284d, 284e, in which light from the light sources can mix and spread, is located between each set of LED light sources 286a-286e and respective light emitting region 282a-282e. In the example shown, each set of LED light sources is composed of three LED light sources, but the three LED light sources in each set are not oriented parallel to each other. In contrast to the optical conductors shown in FIGS. 5 and 22, the LED light sources located adjacent the corners of each light emitting region of optical conductor 288, e.g., LED light sources 287 and 289, are oriented to direct light towards the middle of the optical conductor.

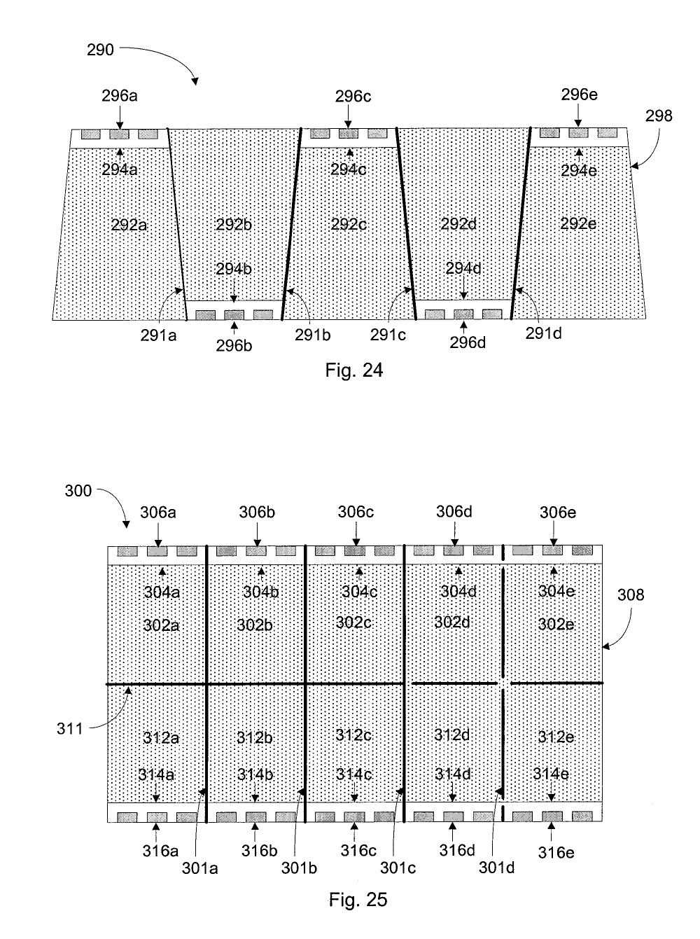

FIG. 24 is a schematic plan view showing an example of a light emitting array 290 in accordance with another embodiment. Light emitting array 290 includes a non-rectangular planar optical conductor 298 in contrast to the optical conductors shown in FIGS. 5, 22, and 23. In the example shown, optical conductor 290 is trapezoidal in shape. Light transmission control elements 291a, 291b, 291c, 291d divide optical conductor 298 into light emitting regions 292a, 292b, 292c, 292d, 292e. Light emitting array 290 additionally includes a respective set of LED light sources 296a, 296b, 296c, 296d, 296e located adjacent each light emitting region 296a-296e. A transition region 294a, 294b, 294c, 294d, 294e, in which light from the light sources can mix and spread, is located between each set of LED light sources 296a-296e and respective light emitting region 292a-292e. In the example shown, optical conductor 298 has two light input surfaces opposite one another and sets of LED light sources 296a, 296c, and 296e are located adjacent the light input surface on one side of optical conductor 298 and sets of LED light sources 296b and 296d are located adjacent the light input surface on the opposite side of the optical conductor. Furthermore, alternate ones of light transmission control elements 291a-291d are oriented parallel to opposite sides of optical conductor 298. This makes the light emitting regions 292a-292e trapezoidal in shape, with their narrower ends adjacent the LED light sources. This shape of the light emitting regions takes advantage of the lateral spreading of the light emitted by the LED light sources.

FIG. 25 is a schematic plan view showing an example of a light emitting array 300 in accordance with another embodiment. Light emitting array 300 includes a planar optical conductor 308. Light transition control elements 301a, 301b, 301c, 301d and 311 divide optical conductor 308 into a two-dimensional array of light emitting regions, 302a, 302b, 302c, 302d, 302e, 312a, 312b, 312c, 312d, 312e. In some embodiments, one or more of the light transmission control elements extends only part way across the width or along the length of the optical conductor. FIG. 25 shows an example in which light transmission control elements 301d and 311 respectively extend only part way along the length and part way across the width of optical conductor 300. Optical conductor 308 has two light input surfaces opposite one another. Light emitting array 300 additionally includes sets of LED light sources 306a, 306b, 306c, 306d, 306e located adjacent the light input surface on one side of the optical conductor associated with light emitting regions 302a-302e, respectively, and sets of LED light sources 316a, 316b, 316c, 316d, 316e located adjacent the light input surface on the opposite side of the optical conductor associated with light emitting regions 312a-312e, respectively. A transition region 304a, 304b, 304c, 304d, 304e, 314a, 314b, 314c, 314d, 314e, in which light from the LED light sources can mix and spread, is located between each set of LED light sources 306a-306e, 316a-316e and respective light emitting region 302a-302e, 312a-312e.

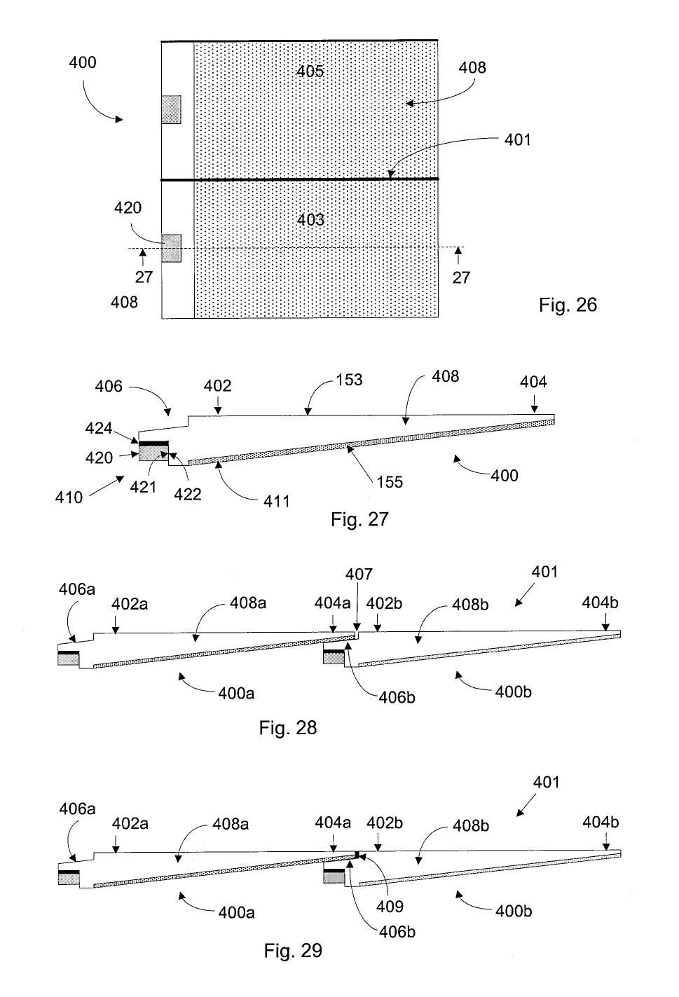

FIG. 26 is a schematic plan view showing a light emitting assembly 400 in accordance with another embodiment. Light emitting assembly 400 includes an optical conductor 408 having a tapered cross-sectional shape. Light emitting assembly 400 additionally includes LED light sources, including an LED light source 420. Optical conductor 408 has a light transmission control element 401 that divides the optical conductor into light emitting regions 403 and 405.

FIG. 27 is a schematic cross sectional view showing light emitting assembly 400 taken along a line 27-27 in FIG. 26. Optical conductor 408 has a front major surface 153 and a back major surface 155 opposite light-emitting major surface 153. When light emitting assembly 400 is arranged to illuminate an LCD panel (not shown), the front major surface 153 of optical conductor 408 faces the LCD panel and back major surface 155 is remote from the LCD panel. Light source housings are defined in optical conductor 408 in each of which one or more LED light sources is mounted. FIG. 27 shows a light source housing 410 defined in optical conductor 408 and an LED light source 420 mounted in the light source housing. An opaque layer is located between the LED light source and the front major surface of the optical conductor to block stray light. FIG. 27 shows opaque layer 424 located in light source housing 410 and oriented parallel to front major surface 153.

In a plane orthogonal to front major surface 153, optical conductor 408 has a tapered cross sectional shape that increases the fraction of the light generated by LED light source 420 that is emitted from front major surface 153. Optical conductor 408 has a thickness in the above-mentioned plane. The thickness decreases of optical conductor 408 distally from light source housing 410, so that a distal portion 404 of the optical conductor is thinner than a proximal portion 402.

In the proximal portion 402 of optical conductor 400, front major surface 153 includes a step that defines an open ended recess 406 in proximal portion 402 adjacent light source housing 410. Recess 406 will be further described with reference to FIG. 28, which is a cross sectional view showing a light emitting assembly 401 composed of two instances 400a, 400b of light emitting assembly 400 arranged in tandem with the distal portion 404a of the optical conductor 408a of light emitting assembly 400a accommodated within a recess 406b defined in the proximal portion 402b of the optical conductor 408b of light emitting assembly 400b. Overlapping the light source housing of optical conductor 408b with the distal portion 404a of optical conductor 408a maximizes the size of the light emitting area of light emitting assembly 401. The overlapped tandem arrangement of optical conductors 408a, 408b forms an almost continuous, nominally planar light emitting region that extends from the distal end of recess 406a defined in optical conductor 408a to the distal portion 404b of optical conductor 408b. The light emitting region of light emitting assembly 401 is almost twice as wide as that of individual light emitting assemblies 400a, 400b. Additional instances (not shown) of light emitting assembly 400 may be arranged in tandem with light emitting assemblies 400a, 400b to further increase the width of the light emitting surface of light emitting assembly 401.

Optical conductors 408a, 408b are positioned such that the distal end of optical conductor 408a and the distal end of recess 406b in the proximal portion 402b of optical conductor 408b are separated by a gap 407. Gap 407 reduces the transmission of light between the first and second light emitting assemblies 400a, 400b. In the example shown in FIG. 28, gap 407 is an air gap.

FIG. 29 is a cross-sectional view showing another configuration of a light emitting assembly 401 in which gap 407 is filled with opaque material 409 that prevents the transmission of light between adjacent light emitting assemblies. In an example, opaque material 409 is light absorbing material, e.g., black material inserted or deposited into gap 407. In another example, opaque material 409 is reflective material, e.g., reflective metal inserted or deposited into gap 407. Opaque material 409 may additionally be located on the surface of recess 406b juxtaposed with the distal portion of optical conductor 408a to provide opaque layer 424.

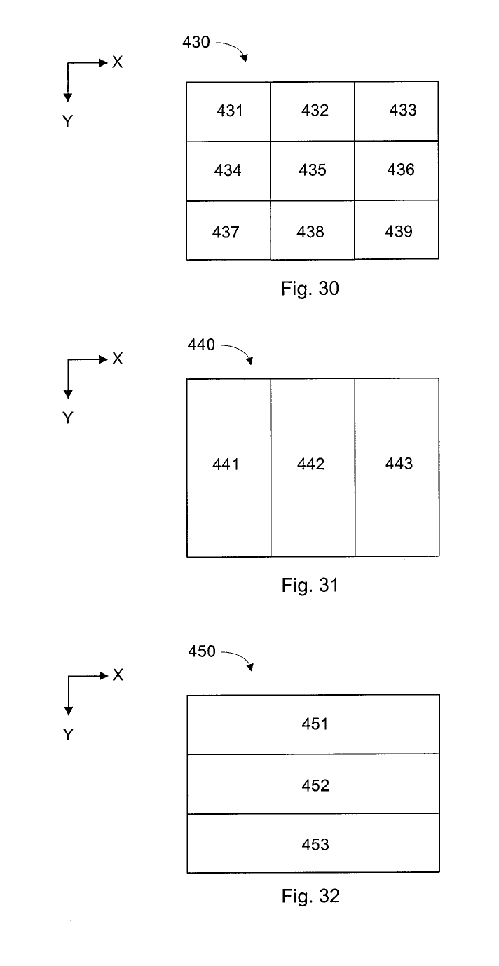

A light emitting assembly can be composed of a 1-dimensional or 2-dimensional array of light emitting assemblies similar to light emitting assembly 400 described above with reference to FIG. 27. Alternatively, a single such light emitting assembly can constitute the entire light emitting assembly. FIG. 30 is a schematic plan view showing a light emitting assembly 430 composed of a 2-dimensional, 3×3 array of optical conductors 431-439. FIG. 31 is a schematic plan view showing a light emitting assembly 440 composed of optical conductors 441-443 arrayed only in the X direction. FIG. 32 is a schematic plan view showing a light emitting assembly 450 composed of optical conductors 451-453 arrayed only in the Y direction.

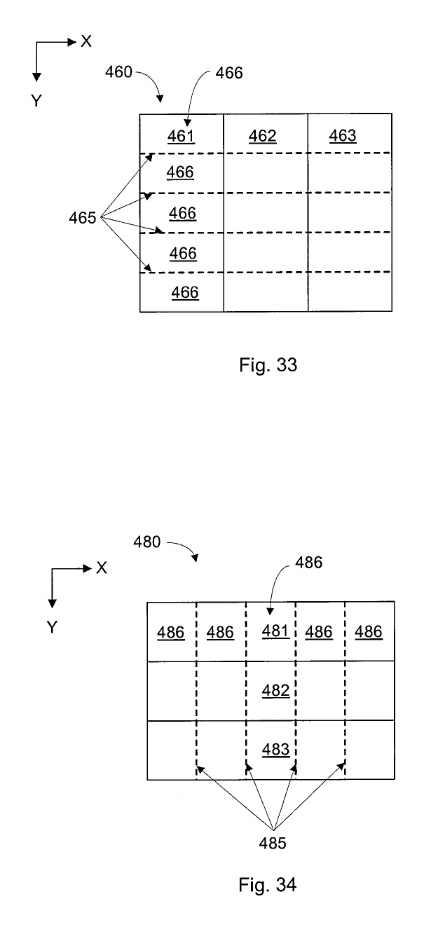

Examples of light emitting assemblies will be described next with reference to FIGS. 33 and 34. FIG. 33 is a schematic plan view showing a light emitting assembly 460 composed of optical conductors 461, 462, 463 arrayed only in the X direction. Light transmission control elements 465 extend in the X direction to divide each optical conductor 461-463 into light emitting regions 466 arrayed in the Y direction. Thus, light emitting assembly 460 has a 2-dimensional array of light emitting regions 466, each of which is independently operable.

FIG. 34 is a schematic plan view showing a light emitting assembly 480 composed of optical conductors 481, 482, 483 arrayed only in the Y direction. Light transmission control elements extend in the Y direction to divide each optical conductor into light emitting regions 486 arrayed in the X direction. Thus light emitting assembly 480 has a 2-dimensional array of light emitting regions 486, each of which is independently operable. Numerous other arrangements are also possible. In some embodiments, a row or a column of the above described independently operable light emitting regions are operated as a single unit.

FIG. 35 is a schematic perspective view showing a liquid crystal display apparatus 500 in accordance with an embodiment of the present invention. Display apparatus 500 is composed of a light emitting assembly 501 and an LCD panel 502. Light emitting assembly 501 functions as a backlight. Display apparatus 500 additionally includes a light conditioning clement 510 located between light emitting assembly 501 and LCD panel 502 to increase the uniformity of the illumination of the LCD panel. Light conditioning element 510 is typically composed of one or more, or multiple ones, of a diffuser film, a diffuser plate, and a prismatic film. In the conventional example shown in FIG. 2, diffuser plate 110, diffuser film 112 and prism film 114 constitute a light conditioning element. One or more of the constituents of the light conditioning element may include a pattern of well-defined micro optical elements.

LCD panel 502 includes an active matrix substrate 504, a counter-substrate 506, and a liquid crystal layer 505 between them. Typically, the active matrix substrate contains an array of thin film transistors (TFTs) but thin film diodes (TFDs) have also been used, particularly in smaller displays. Typically, a color filter array is located on the counter-substrate, but color filter-on-array (CFA) technologies, in which the color filter array and TFT array are on the same substrate, are also available and can be used. In displays with frame sequential illumination, the color filter array is not needed. Polarizers 503 and 507 are located adjacent each substrate 504 and 506.

FIG. 36 is a block diagram showing an example of drive circuitry suitable for driving TFT array 525 and the light emitting regions 531, 532, and 533 of light emitting assembly 501. In this example, light emitting assembly 501 is divided in the Y direction into light emitting regions 531-533 in a manner similar to light emitting regions 451-453 shown in FIG. 32. However, 1-dimensional arrays arrayed only in the X direction and 2-dimensional arrays of light emitting regions are also possible. Frame memory 522 is a memory device that temporarily stores one frame of pixel data. Each item of pixel data represents the intensity of the pixel controlled by a respective pixel circuit (not shown) of TFT array 525. The pixel data stored in the frame memory is sent to the LCD controller 521. The LCD controller controls the operation of the entire LCD panel based on the pixel data from the frame memory and input signals from outside the block diagram.

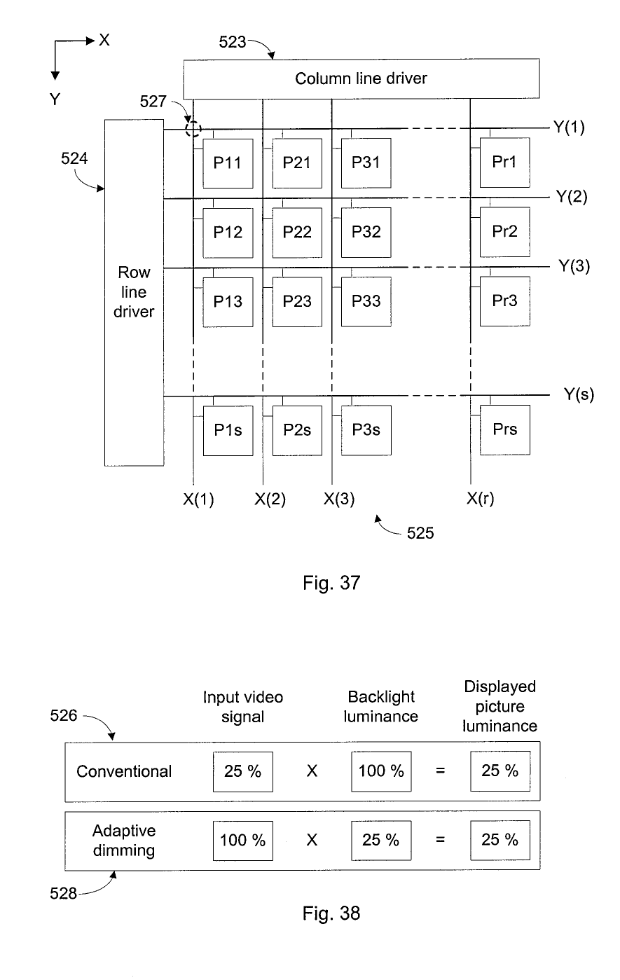

TFT array 525 is shown in greater detail in FIG. 37. Row lines Y(1) through Y(s) (where s is a positive integer that is a multiple of 3) extend in the X direction and are connected to a row line driver 524. The row line driver sequentially imposes row select pulses on the row lines. Column lines X(1) through X(r) (where r is a positive integer) extend in the Y direction and are connected to a column line driver 523. The column line driver sends the pixel data to the pixel circuits via the column lines. The column lines and row lines cross at cross points. For example, column line X(1) and row line Y(1) cross at a cross point 527. A respective pixel circuit P11-Prs is located adjacent to each cross point, and is connected to the row line and the column line that cross at the cross point. For example, pixel circuit P11 is connected to row line Y(1) and column line X(1) that cross at cross point 527. Each pixel circuit includes such elements as wiring, thin film transistors, and capacitors.

Row line driver 524 receives signals from LCD controller 524 and sequentially imposes row select pulses on row lines Y(1) through Y(s). Column line driver 523 receives signals from the LCD controller and supplies pixel data to the pixel circuits via the column lines. Each row select pulse causes the pixel data imposed by the column line driver 523 on the column lines to be written to the pixel circuits in the row.

Light emitting region control circuits 541, 542, 543 operate light emitting regions 531, 532, 533 in response to light emitting region control signals received from LCD controller 521. In the example shown in FIGS. 36 and 37, LCD panel 502 is illuminated by three light emitting regions of approximately the same size. Accordingly, a portion of LCD panel 502 including row lines Y(1) through Y(s/3) is illuminated by light emitting region 531, a portion of the LCD panel including row lines Y(s/3+1) through Y(2s/3) is illuminated by light emitting region by 32, and a portion of LCD panel 502 including row lines Y(2s/3+1) through Y(s) is illuminated by light emitting region 533. In this example, the number of row lines (s) is an integral multiple of the number of light emitting regions; however, the number of light emitting regions and the dimensions of each light emitting region can be adjusted to accommodate any number of row lines. In the example shown in FIGS. 36 and 37, the light emitting regions are arrayed the Y direction. In another example, the light emitting regions are arrayed in the X direction, or all in both the X and Y directions.

Using independently operable light emitting regions enables the implementation of certain dynamic backlighting techniques that provide localized, real-time control of at least the intensity of the backlighting in response to an incoming video data signal. One example is the adaptive backlight dimming illustrated in FIG. 38. In conventional backlighting 526, the backlight intensity is maintained at a prescribed value regardless of the intensity represented by the video data signal. With adaptive dimming 528, when the video data signal represents a low intensity, the input signal to the LCD panel is increased and the effective intensity of the backlighting is decreased to give a displayed picture intensity that is substantially identical to that provided by conventional backlighting. The effective intensity of the backlighting can be reduced by reducing a current drive, a voltage drive, a current pulse duty cycle, a voltage pulse duty cycle, or another suitable drive parameter applied to the LED light sources optically coupled to the respective light emitting region. Adaptive dimming can be effective for reducing the electrical power consumption of the light emitting assembly, improving black level, and increasing the number of gray levels for low intensity images, thereby providing an effective bit depth (i.e., the number of levels in the grey scale) greater than the nominal bit depth of the LCD panel.

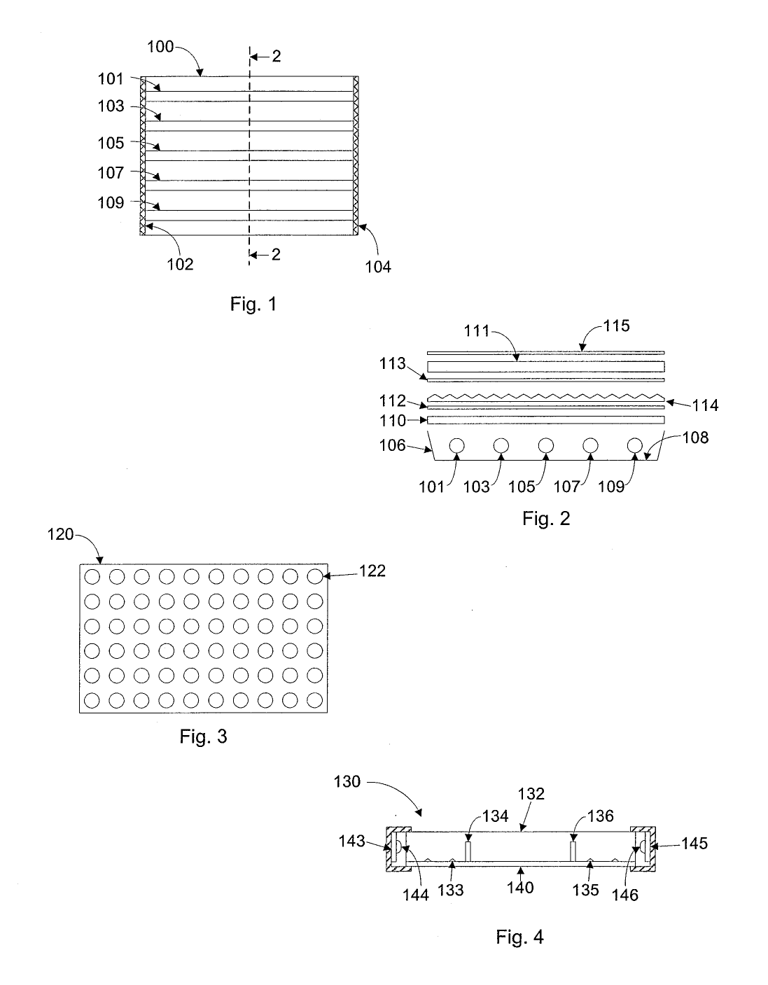

Adaptive dimming can be implemented in zero-, one- and two-dimensional (0D, 1D, and 2D) configurations. 0D-dimming means that the entire backlight is uniformly dimmed. 1D-dimming (line dimming) is suitable for use in displays backlit by fluorescent lamps such as CCFLs (cold cathode fluorescent lamps), HCFLs (hot cathode fluorescent lamps), and EEFLs (external electrode fluorescent lamps). One-dimensional dimming can be implemented in displays backlit by LED light sources by dividing the light emitting area into light emitting regions arrayed in the X direction or in the Y direction, with each light emitting region being independently operable. Two-dimensional dimming is implemented in displays backlit by LED light sources by dividing the light emitting area into light emitting regions arrayed in both the X and Y directions. Two-dimensional adaptive dimming is not possible with the conventional light emitting assembly 100 shown in FIG. 1. Two-dimensional adaptive dimming can be implemented in displays backlit by LEDs or OLEDs.

Adaptive backlight boosting is another technique that can be implemented in 0-D, 1-D, and 2-D configurations. In adaptive backlight boosting, the effective intensity of the backlighting is increased in response to a video data signal representing a high image intensity, such that the displayed image intensity is also increased. The effective intensity of the backlighting can be increased by increasing a current drive, a voltage drive, a current pulse duty cycle, a voltage pulse duty cycle or another suitable drive parameter applied to the LED light sources optically coupled to the respective light emitting region. Adaptive backlight boosting is implemented in combination with adaptive backlight dimming because it takes advantage of the margin (e.g., electrical power and system temperature) provided by adaptive dimming. The perceived contrast and brightness can be increased. For more information on adaptive dimming and boosting, refer to: P. de Greef, et al., Adaptive Scanning, 1-D Dimming, and Boosting Backlight for LCD-TV Systems, 14 J. OF THE SID, 1103-1110 (2006) and T. Shiga, et al., Power Saving and Enhancement of Gray-Scale Capability of LCD TVs with an Adaptive Dimming Technique, 16 J. OF THE SID, 311-316 (2008).

Because of the slow response of nematic liquid crystal materials to an applied drive voltage, moving objects can appear to have blurred edges. Impulse driving, which can be realized with scanning backlighting, can improve this aspect of image quality. Backlight scanning is synchronized to the row scanning of the LCD panel. The pixels in the region of the LCD panel corresponding to each light emitting region of the light emitting assembly are illuminated by each light emitting region only after the liquid crystal material therein has reached or exceeded a defined optical response level.

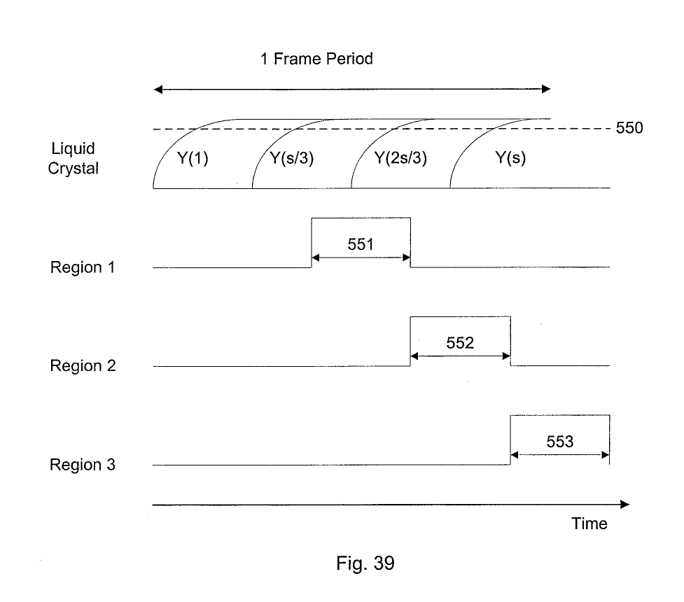

An example of impulse driving will now be described in with reference to FIGS. 36, 37, and 39. As described above, the portion of LCD panel 502 including row lines Y(1) through Y(s/3) is illuminated by light emitting region 531, the portion including row lines Y(s/3+1) through Y(2s/3) is illuminated by light emitting region 532, and the portion including row lines Y(2s/3+1) through Y(s) is illuminated by light emitting region 533. FIG. 39 is a schematic timing chart showing the optical response of the liquid crystal material at various locations (row lines) in the LCD panel and the timing of the illumination provided by light emitting regions 531-533. Row line driver 524 sequentially imposes row select pulses on row line Y(1) through row line Y(s) starting at row line Y(1).

FIG. 39 also shows representative response curves for pixels whose pixel circuits are connected to row lines Y(1), Y(s/3), Y(2s/3), and Y(s), respectively. Light emitting region 531 is turned on during illumination period 551, which begins only after the liquid crystal material of the pixels whose pixel circuits are connected to row lines Y(1) through Y(s/3) have reached or exceeded a defined optical response level 550. Similarly, light emitting region 532 is turned on during illumination period 552, which begins only after the liquid crystal material of the pixels whose pixel circuits are connected to row lines Y(s/3+1) through Y(2s/3) have reached or exceeded defined optical response level 550. Finally, light emitting region 533 is turned on during illumination period 553, which begins only after the liquid crystal material of the pixels whose pixel circuits are connected to row lines Y(2s/3+1) through Y(s) has reached or exceeded defined optical response level 550.

However, with impulse driving, image flicker may become visible in bright images. To reduce the image flicker, a second light pulse per frame can be added, resulting in 50 (for 25 frames per second video signals) or 60 (for 30 frames per second video signals) light pulses per second per light emitting region. Dual illumination pulses reduce the perception of image flicker because the human eye functions as a temporal low-pass filter. However, double edges can become visible in moving images with dual-pulse illumination.

Adaptive dual pulse backlighting has been developed to provide a balance between reducing image flicker in bright images and reducing double edges in moving images. Adaptive dual pulse illumination can be implemented in 0-D, 1-D, and 2-D configurations. As in adaptive dimming and boosting, 2-D adaptive dual pulse backlighting can be implemented with an array of individually controllable light emitting regions. For bright images with little motion where flicker reduction is important, the backlight is operated in a dual pulse mode. For moving images where the scene is not bright, double edges are eliminated by operating the backlight in a single pulse mode. Transitions between the single pulse and dual pulse modes can be implemented by gradually changing the phase, the pulse-width, or the intensity of the second pulse relative to the first pulse. Furthermore, in scenes that include both motion and high brightness, an interpolation of the single pulse and dual pulse modes is used. Two-dimensional adaptive dual pulse illumination is useful because the interpolation between single pulse and dual pulse modes can be optimized for each independently controllable light emitting region. For more information on adaptive pulse driving, refer to P. de Greef, et al., Adaptive Scanning, 1-D Dimming, and Boosting Backlight for LCD-TV Systems, 14 J. OF THE SID, 1103-1110 (2006).

The number of light emitting regions into which an optical conductor is divided depends on the requirements of each application. However, in accordance with an embodiment of the present invention, an optical conductor will have at least two light emitting regions, with a light transmission control element between adjacent ones of the light emitting regions. The number of independently operable light emitting regions should be less than the number of pixels in the LCD panel. In an example, the number of independently operable light emitting regions is less than the number of pixels in the LCD panel by at least two orders of magnitude. In another example, the number of independently operable light emitting regions is less than the number of pixels in the LCD panel by at least three orders of magnitude.

FIG. 37 shows row lines generally extending in the X direction and column lines generally extending in the Y direction. In this example, the total number of light emitting regions along a particular column line (e.g., column line X(1) shown in FIG. 37) is less than the number of row lines (e.g., row lines Y(1)-Y(s) shown in FIG. 37). In another example, the total number of light emitting regions is less than the number of row lines by at least one order of magnitude. Similarly, the total number of light emitting regions along a particular row line (e.g., row line Y(1) shown in FIG. 37) is less than the number of column lines (e.g., column lines X(1)-X(r) shown in FIG. 37). In another example, the total number of light emitting regions along a particular row line is less than the number of column lines by at least one order of magnitude.

This disclosure describes the invention in detail using illustrative embodiments. However, the invention defined by the appended claims is not limited to the precise embodiments described.

1. A liquid crystal display apparatus, comprising:
a liquid crystal display (LCD) panel;
a light emitting assembly arranged to illuminate the liquid crystal display panel, the light emitting assembly comprising:
a planar optical conductor characterized by a length and a width, the optical conductor comprising:
a light input surface;
light transmission control elements that divide the optical conductor into independently operable light emitting regions; and
well defined light extracting optical elements on or in the optical conductor, the optical elements configured to redirect light received at the light input surface out from the optical conductor;
a light emitting diode (LED) light source optically coupled to each of the light emitting regions of the optical conductor and located adjacent the light input surface thereof, the LED light source configured to generate light having an output distribution defined by a greater width component than height component, and being small relative to the length and width of the optical conductor; and
a light conditioning element between the light emitting assembly and the liquid crystal display panel.

2. The liquid crystal display apparatus of claim 1, wherein the light transmission control elements each comprise a groove defined by the optical conductor.

3. The liquid crystal display apparatus of claim 1, wherein the light transmission control elements comprise opaque material.

4. The liquid crystal display apparatus of claim 1, wherein the optical conductor comprises a first layer and a second layer.

5. The liquid crystal display apparatus of claim 4, wherein:
the light transmission control elements each comprise a groove defined in the first layer; and
the groove is filled with material of the second layer.

6. The liquid crystal display apparatus of, claim 1 wherein:
the apparatus additionally compromises a light source housing defined in each light emitting region of the optical conductor; and
the respective LED light source is mounted in the light source housing.

7. The liquid crystal display apparatus of claim 1, wherein:
at least three different LED light sources are adjacent each light emitting region; and
the at least three different LED light sources are sources of light of different colors.

8. The liquid crystal display apparatus of claim 7, wherein each of the at least three different light emitting diode light sources is sequentially operable during a frame period of the liquid crystal display apparatus.

9. The liquid crystal display apparatus of claim 1, wherein:
the light emitting regions comprise a first light emitting region and a second light emitting region adjacent the first light emitting region;
the light input surface is a first light input surface and the optical conductor additionally comprises a second light input surface opposite the first light input surface;
the LED light source adjacent the first light emitting region is located adjacent the first light input surface and the LED source adjacent the second light emitting region is adjacent the second light input surface.

10. The liquid crystal display apparatus of claim 1, wherein each light emitting region is trapezoidal in shape and has a shorter side and a longer side, and the LED light source located adjacent each light emitting region is located adjacent to the shorter side thereof.

11. The liquid crystal display apparatus of claim 1, additionally comprising additional optical conductors arranged in tandem with the optical conductor, adjacent ones of the optical conductors separated by a gap.

12. The liquid crystal display apparatus of claim 11, wherein the gap or recess is filled with opaque material.

13. The liquid crystal display apparatus of claim 1, wherein:
the LCD panel comprises row lines extending in a first direction and column lines extending in a second direction, orthogonal to the first direction; and
the light emitting regions of the light emitting assembly are arrayed in the second direction; and
the light emitting regions sequentially illuminate the LCD panel during each frame period of the LCD panel.

14. The liquid crystal display apparatus of claim 1, wherein the light emitting regions are sequentially illuminated at least twice during each frame period.

15. The liquid crystal display apparatus of claim 1, wherein:
the light emitting regions are arranged in an array; and
light emitted by each light emitting region has an intensity determined in response to gray level data relating to a region of the LCD panel illuminated by the light emitting region.

16. The liquid crystal display apparatus of claim 1, wherein:
the light emitting regions are arranged in an array; and
light emitted by each light emitting region has a duty cycle determined in response to gray level data relating to a region of the LCD panel illuminated by the light emitting region.

17. The liquid crystal display apparatus of claim 1, in which the light conditioning element comprises at least one of a diffuser film, a diffuser plate, and a prismatic film.

18. The liquid crystal display apparatus of claim 1 additionally comprising a reflective element adjacent a back major surface of the optical conductor.
